(19) United States
(12) Patent Application Publication
(10) Pub. No.: US 2022/0108019 A1
(43) Pub. Date: Apr. 7, 2022

(54) SYSTEM FOR ENHANCED DATA SECURITY IN A VIRTUAL REALITY ENVIRONMENT

(71) Applicant: BANK OF AMERICA CORPORATION, Charlotte, NC (US)

(72) Inventors: Vasuki Anand, Sembakkam (IN); Madhusudhanan Krishnamoorthy, Hasthinapuram (IN)

(73) Assignee: BANK OF AMERICA CORPORATION, Charlotte, NC (US)

(21) Appl. No.: 17/060,152

(22) Filed: Oct. 1, 2020

(51) Int. Cl. G06F 21/57; G06F 21/62; G06F 21/31; G06N 20/00

(52) U.S. Cl. CPC G06F 21/577; G06F 21/629; G06F 2221/033; G06N 20/00; G06F 21/31

(57) ABSTRACT

Systems, computer program products, and methods are described herein for enhanced data security in a virtual reality environment. The present invention is configured to initiate an adversarial testing protocol on the virtual reality platform; transmit one or more adversarial inputs to one or more trained machine learning models associated with the virtual reality platform; receive one or more predicted class labels for the one or more adversarial inputs; compare the one or more predicted class labels with one or more observed class labels associated with the one or more adversarial inputs; determine an error rate of the one or more trained machine learning models; determine a first exposure score for the virtual reality platform based on at least the error rate; transmit control signals configured to cause the computing device associated with the user to display the first exposure score for the virtual reality platform.

### FIELD OF THE INVENTION

The present invention embraces a system for enhanced data security in a virtual reality environment.

### BACKGROUND

As evolving virtual reality technologies are embraced and integrated by entities into their technical environments for training and other purposes, there need to carefully consider the privacy, security, and safety aspects of these technologies. Virtual reality platforms provide the user with a perception of being physically present in a non-physical world, where the perception is created by surrounding the user of the VR device/platform in images, sounds, and other stimuli to provide an engrossing environment.

There is a need for a system to preserve the integrity and provide enhanced data security for the virtual reality platform

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for enhanced data security in a virtual reality environment is presented. The system comprising: at least one non-transitory storage device storing a virtual reality platform; and at least one processing device coupled to the at least one non-transitory storage device, wherein the at least one processing device is configured to: initiate the virtual reality platform for display on a computing device associated with a user; initiate an enhanced data security engine on the virtual reality platform, wherein initiating further comprises: initiating an adversarial testing protocol on the virtual reality platform; transmitting, via the adversarial testing protocol, one or more adversarial inputs to one or more trained machine learning models associated with the virtual reality platform; electronically receiving, from the one or more trained machine learning models, one or more predicted class labels for the one or more adversarial inputs; compare the one or more predicted class labels with one or more observed class labels associated with the one or more adversarial inputs; determine an error rate of the one or more trained machine learning models based on at least comparing the one or more predicted class labels with the one or more observed class labels; determine a first exposure score for the virtual reality platform based on at least the error rate of the one or more trained machine learning models; transmit control signals configured to cause the computing device associated with the user to display the first exposure score for the virtual reality platform.

In some embodiments, the at least one processing device is further configured to: determine, using the one or more trained machine learning models, that at least one of the one or more adversarial inputs matches one or more existing artifacts in the virtual reality platform based on at least the one or more predicted class labels; introduce, using a noise generator, a noise value on the at least one of the one or more adversarial inputs that matches the one or more existing artifacts; generate a noisy version of the at least one of the one or more adversarial inputs based on at least introducing a noise value to the at least one of the one or more adversarial inputs that matches the one or more existing artifacts; and transmit control signals configured to cause the computing device associated with the user to display the noisy version of the at least one of the one or more adversarial inputs on the virtual reality platform.

In some embodiments, the at least one processing device is further configured to: initiate the enhanced data security engine on the virtual reality platform, wherein initiating further comprises: initiating an authentication testing protocol on the virtual reality platform; transmitting a combination of authorized access requests and unauthorized access requests to access one or more features of the virtual reality platform; electronically receiving, from the virtual reality platform, a response to the combination of authorized access requests and unauthorized access requests; and determining a second exposure score for the virtual reality platform based on at least the response to the combination of authorized access requests and unauthorized access requests.

In some embodiments, the at least one processing device is further configured to transmit the combination of authorized access requests and unauthorized access requests, wherein the authorized access requests comprises requests with an authentication level that meets an authorization level required to access at least a portion of the one or more features of the virtual reality platform.

In some embodiments, the at least one processing device is further configured to: transmit the combination of authorized access requests and unauthorized access requests, wherein the unauthorized access requests comprises requests with an authentication level that does not meet the authorization level required to access at least the portion of the one or more features of the virtual reality platform.

In some embodiments, the at least one processing device is further configured to: electronically receive information associated with the virtual reality platform, wherein the information comprises at least information associated with a content presented on the virtual reality platform, authentication requirements associated with the virtual reality platform, and adversarial management protocols associated with the virtual reality platform; initiate a distribution detection protocol on the information associated with the virtual reality platform; determine, using the distribution detection protocol, a distribution of one or more user groups likely to use the virtual reality platform based on at least the information associated with the virtual reality platform; determine a skewness factor associated with the distribution of the one or more user groups likely to use the virtual reality platform; and determine a third exposure score based on at least the skewness factor associated with the distribution of the one or more user groups likely to use the virtual reality platform.

In some embodiments, the at least one processing device is further configured to: initiate an equilibrium testing protocol on the virtual reality platform, wherein initiating further comprises: simulating a user balance equilibrium test on the virtual reality platform, wherein simulating further comprises physically moving the computing device in one or more axial directions; and electronically receiving, from one or more sensors associated with the computing device, a response to each movement in the one or more axial directions, wherein the response comprises at least an alert notification.

In some embodiments, the at least one processing device is further configured to: determine a magnitude of motion associated with movement of the computing device in each of the one or more axial directions; determine a predetermined threshold associated with the magnitude of motion, wherein any movement along the one or more axial directions with the magnitude of motion greater than the predetermined threshold is considered a triggering motion; determine whether the alert notifications received from the one or more sensors in response to the movement of the computing device in the one or more axial directions matches the triggering motion in each of the one or more axial directions; and determine a fourth exposure score associated with virtual reality platform based on at least a number of alert notifications that matches the triggering motion in each of the one or more axial directions.

In some embodiments, the at least one processing device is further configured to: assign a weight to the first exposure score, the second exposure score, the third exposure score, and the fourth exposure score; determine an overall exposure score based on at least the first exposure score, the second exposure score, the third exposure score, and the fourth exposure score, wherein the overall exposure score is a weighted average of the first exposure score, the second exposure score, the third exposure score, and the fourth exposure score; and transmit control signals configured to cause the computing device associated with the user to display the overall exposure score for the virtual reality platform.

In another aspect, a computer program product for enhanced data security in a virtual reality environment is presented. The computer program product comprising a non-transitory computer-readable medium storing a virtual reality platform and comprising code causing a first apparatus to: initiate the virtual reality platform for display on a computing device associated with a user; initiate an enhanced data security engine on the virtual reality platform, wherein initiating further comprises: initiating an adversarial testing protocol on the virtual reality platform; transmitting, via the adversarial testing protocol, one or more adversarial inputs to one or more trained machine learning models associated with the virtual reality platform; electronically receiving, from the one or more trained machine learning models, one or more predicted class labels for the one or more adversarial inputs; compare the one or more predicted class labels with one or more observed class labels associated with the one or more adversarial inputs; and determine an error rate of the one or more trained machine learning models based on at least comparing the one or more predicted class labels with the one or more observed class labels; determine a first exposure score for the virtual reality platform based on at least the error rate of the one or more trained machine learning models; and transmit control signals configured to cause the computing device associated with the user to display the first exposure score for the virtual reality platform.

In yet another aspect, a method for enhanced data security in a virtual reality environment is presented. The method comprising: initiating a virtual reality platform for display on a computing device associated with a user; initiating an enhanced data security engine on the virtual reality platform, wherein initiating further comprises: initiating an adversarial testing protocol on the virtual reality platform; transmitting, via the adversarial testing protocol, one or more adversarial inputs to one or more trained machine learning models associated with the virtual reality platform; electronically receiving, from the one or more trained machine learning models, one or more predicted class labels for the one or more adversarial inputs; compare the one or more predicted class labels with one or more observed class labels associated with the one or more adversarial inputs; and determine an error rate of the one or more trained machine learning models based on at least comparing the one or more predicted class labels with the one or more observed class labels; determining a first exposure score for the virtual reality platform based on at least the error rate of the one or more trained machine learning models; and transmitting control signals configured to cause the computing device associated with the user to display the first exposure score for the virtual reality platform.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for enhanced data security in a virtual reality environment, in accordance with an embodiment of the invention;

FIG. 2 illustrates a process flow for enhanced data security in a virtual reality environment, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

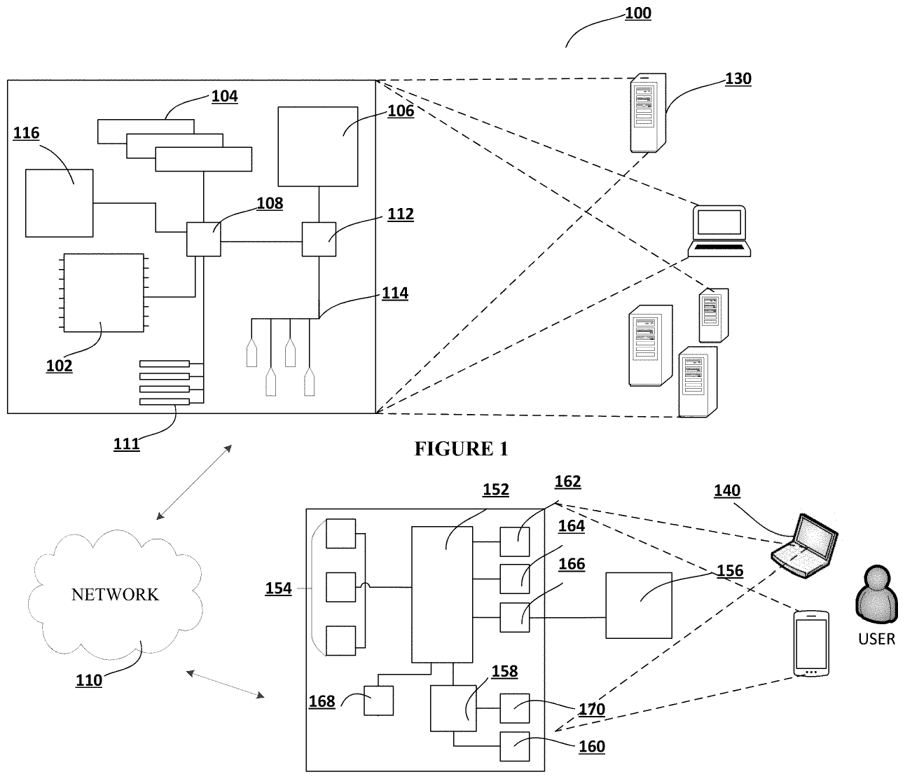

FIG. 1 presents an exemplary block diagram of the system environment for enhanced data security in a virtual reality environment 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is a user of the user input system 140. The user input system 140 is intended to represent various forms of mobile devices, such as laptops, personal digital assistants, augmented reality (AR) devices, virtual reality (VR) devices, extended reality (XR) devices, and/or the like, and non-mobile devices such as desktops, video recorders, audio/video player, radio, workstations, and/or the like. The user may be a person who uses the user input system 140 to execute one or more processes described herein using one or more applications stored thereon. The one or more applications may be configured to communicate with the system 130, execute a transaction, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, video recorders, audio/video player, radio, workstations, personal digital assistants, servers, automated teller machine devices, electronic kiosk devices, blade servers, mainframes, or any combination of the aforementioned. The user input system 140 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

In some embodiments, the system 130 may be configured to access, via the 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application, and allows memory reuse for better utilization of the memory resources when the data sizes are large.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate. A user input system 140 used for VR, AR and/or XR purposes may include one or more magnetometers—to detect the direction that the user is facing while using the user input system 140, accelerometers—to determine whether the user input system 140 is in line with the pull of gravity and/or gyroscopes—to calculate orientation. The use of such sensors helps to achieve true six-degrees-of-freedom (6DoF), which covers all the degrees of motion for a rigid body in space.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140, or may also store applications or other information therein. In some embodiments, expansion memory may include instructions to carry out or supplement the processes described above, and may include secure information also. For example, expansion memory may be provided as a security module for user input system 140, and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation—and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

As evolving virtual reality technologies are embraced and integrated by entities into their technical environments for training and other purposes, there need to carefully consider the privacy, security, and safety aspects of these technologies. Virtual reality platforms provide the user with a perception of being physically present in a non-physical world, where the perception is created by surrounding the user of the VR device/platform in images, sounds, and other stimuli to provide an engrossing environment. There is a need for a system to preserve the integrity and provide enhanced data security for the virtual reality platform.

The present invention provides the functional benefit of implementing a plurality of penetration testing protocols on the virtual reality platform to identify and analyze any security exposures, privacy issues, content classification issues, and/or the like.

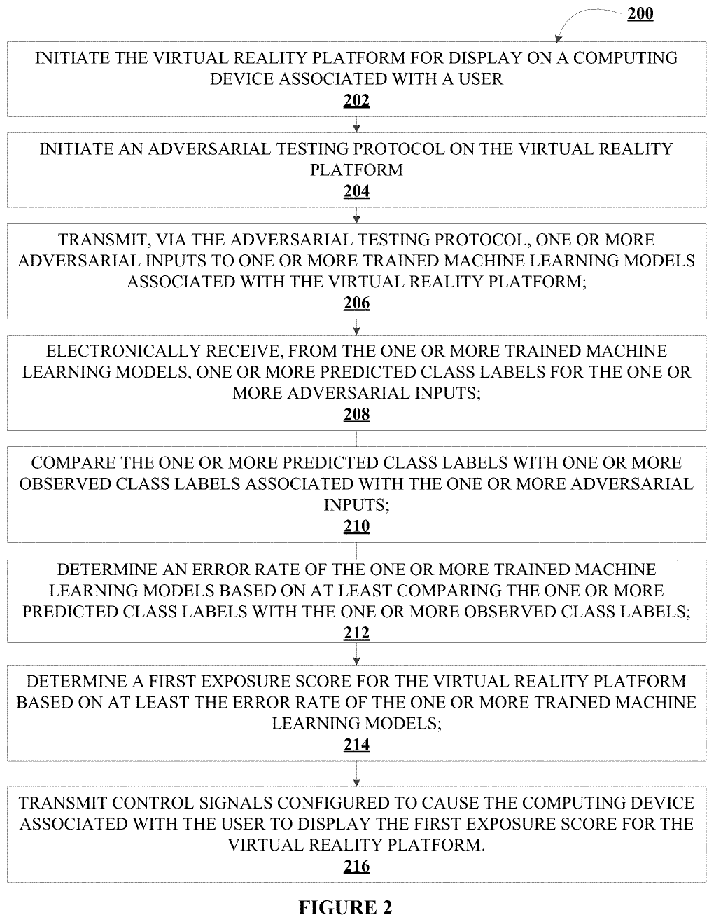

FIG. 2 illustrates a process flow for enhanced data security in a virtual reality environment 200, in accordance with an embodiment of the invention. As shown in block 202, the process flow includes initiating the virtual reality platform for display on a computing device associated with a user. Virtual reality (VR) is a simulated experience that can be similar to or completely different from the real world. Virtual reality platforms are applications that make use of VR, an immersive sensory experience that digitally simulates a virtual environment. Applications have been developed in a variety of domains, such as education, architectural and urban design, digital marketing and activism, engineering and robotics, entertainment, fine arts, healthcare and clinical therapies, heritage and archaeology, occupational safety, social science, and psychology. Currently, standard virtual reality systems use either virtual reality headsets, or multi-projected environments to generate realistic images, sounds and other sensations that simulate a user's physical presence in a virtual environment. A user using virtual reality equipment is able to look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic technology. For purposes of the invention, a computing device, and/or a user input system, as used herein may include one or more devices and/or environments used to simulate a virtual reality experience for the user.

In some embodiments, the virtual reality platform may be generated by leveraging artificial intelligence and machine learning techniques to create an immersive experience. The advancement in object recognition using CNN, and representation of semantic information (allowing the separation of image context from style) may be used to generate unique images of maps, landscapes, and environments within the virtual reality platform. In addition to creating environments, artificial intelligence and machine learning techniques may be implemented to analyze user input received via the computing device to generate a seamless interaction between the user and the virtual reality platform. In this regard, the virtual reality platform may include one or more pre-trained machine learning models that are used to receive user input, and classify the user input into a set of actions to be implemented within the realm of the virtual reality platform.

In some embodiments, the system may be configured to initiate an enhanced data security engine on the virtual reality platform to simulate unauthorized access and test classification and prediction parameters of trained machine learning models associated with the virtual reality platform. To this extent, as shown in block 204, the process flow includes initiating an adversarial testing protocol on the virtual reality platform. In some embodiments, the adversarial testing protocol may be used to test the robustness of the trained machine learning models associated with the virtual reality platform. Most trained machine learning models are designed to work on specific problem sets in which the training and test data are generated from the same statistical distribution (IID). When those models are applied to the real world, adversarial data received from users may supply data that violates that statistical assumption, thus resulting in a higher rate of misclassifications within the virtual reality platform. Thus, by implementing adversarial testing, the system may be configured to determine a robustness of the virtual reality platform.

Next, as shown in block 206, the process flow includes transmitting, via the adversarial testing protocol, one or more adversarial inputs to one or more trained machine learning models associated with the virtual reality platform. In some embodiments, an adversarial input is an instance with small, intentional feature perturbations that may cause a machine learning model to make a false prediction. For example, in a virtual reality platform, a traffic light may be represented by three circles—a red circle indicating “stop,” an amber circle indicating “prepare to stop,” and a green circle indicating “go.” An adversarial input in this case would be a user input that is a red circle with a different connotation than that assigned by the virtual reality platform. In a perfect virtual reality platform, such an adversarial input must be addressed to ensure that there is no confusion between the meaning of a red circle in the virtual reality platform and a way to demarcate the two meanings.

Next, as shown in block 208, the process flow includes electronically receiving, from the one or more trained machine learning models, one or more predicted class labels for the one or more adversarial inputs. Continuing with the previous example, in some embodiments, the one or more predicted class labels may indicate that the adversarial input of a red circle is a “stop” sign on a traffic light. In some other embodiments, the one or more predicted class labels may indicate that the adversarial input of a red circle is not a “stop” sign on a traffic light, and causes a conflict with existing symbol for a “stop” sign on a traffic light within the virtual reality platform. In some embodiments, the adversarial input is analyzed not only for its visual similarities with objects within the virtual reality platform, but also how it is configured to be used by the user within the virtual reality platform. Based on our previous example, a red circle being introduced to indicate a ball may be acceptable, but a red circle being introduced in commuter traffic simulation may not be acceptable.

Next, as shown in block 210, the process flow includes comparing the one or more predicted class labels with one or more observed class labels associated with the one or more adversarial inputs. In some embodiments, the one or more observed class labels are class labels of the adversarial inputs that represent the true class of the adversarial inputs.

Next, as shown in block 212, the process flow includes determining an error rate of the one or more trained machine learning models based on at least comparing the one or more predicted class labels with the one or more observed class labels. In some embodiments, the error rate may be used to measure of the differences between values (sample or population values) predicted by a model or an estimator and the values observed. The lower the error rate, the better the model is.

In some embodiments, the system may be configured to determine, using the one or more trained machine learning models, that at least one of the one or more adversarial inputs matches one or more existing artifacts/objects in the virtual reality platform based on at least the one or more predicted class labels. In response, the system may be configured to introduce, using a noise generator, a noise value on the at least one of the one or more adversarial inputs that matches the one or more existing artifacts. In response, the system may be configured to generate a noisy version of the at least one of the one or more adversarial inputs based on at least introducing a noise value to the at least one of the one or more adversarial inputs that matches the one or more existing artifacts. In response, the system may be configured to transmit control signals configured to cause the computing device associated with the user to display the noisy version of the at least one of the one or more adversarial inputs on the virtual reality platform. Continuing with our previous example, a red circle being introduced in the field of commuting will cause a conflict and result in a noise being added around the red circle to demarcate the adversarial input.

Next, as shown in block 214, the process flow includes determining a first exposure score for the virtual reality platform based on at least the error rate of the one or more trained machine learning models. In some embodiments, the exposure score may be a calculated number (the score) that reflects the level of exposure in the presence of some exposure factors (e.g., adversarial inputs).

Next, as shown in block 216, the process flow includes transmitting control signals configured to cause the computing device associated with the user to display the first exposure score for the virtual reality platform.

In some embodiments, the system may be configured to initiate an authentication testing protocol on the virtual reality platform. In this regard, the system may be configured to transmit a combination of authorized access requests and unauthorized access requests to access one or more features of the virtual reality platform. In some embodiments, the authorized access requests may include requests with an authentication level that meets an authorization level required to access at least a portion of the one or more features of the virtual reality platform. In some embodiments, the unauthorized access requests may include requests with an authentication level that does not meet the authorization level required to access at least the portion of the one or more features of the virtual reality platform. In some embodiments, the one or more features of the virtual reality platform may be source code associated with the virtual reality platform, one or more user accounts, past user interaction information, alternate accounts associated with the same user, modifications to existing code within the virtual reality platform, input transmission attempts to change hardcoded features, and/or the like. In response, the system may be configured to electronically receive, from the virtual reality platform, a response to the combination of authorized access requests and unauthorized access requests. In response, the system may be configured to determine a second exposure score for the virtual reality platform based on at least the response to the combination of authorized access requests and unauthorized access requests.

In some embodiments, the system may be configured to electronically receive information associated with the virtual reality platform, wherein the information comprises at least information associated with a content presented on the virtual reality platform, authentication requirements associated with the virtual reality platform, and adversarial management protocols associated with the virtual reality platform. In response, the system may be configured to initiate a distribution detection protocol on the information associated with the virtual reality platform. In some embodiments, the system may be configured to determine, using the distribution detection protocol, a distribution of one or more user groups likely to use the virtual reality platform based on at least the information associated with the virtual reality platform. In some embodiments, the system may be configured to determine a skewness factor associated with the distribution of the one or more groups likely to use the virtual reality platform. In response, the system may be configured to determine a third exposure score based on at least the skewness factor associated with the distribution of the one or more user groups likely to use the virtual reality platform.

In some embodiments, the system may be configured to analyze one or more specific aspects of the content presented on the virtual reality platform. In response, the system may be configured to determine the effect of the one or more specific aspects of the content on the distribution of the one or more user groups likely to use the virtual reality platform. If the distribution of any specific user group is skewed more than the other groups, the specific aspects of the content causing such a skewness is identified. In response, the identified aspects are replaced and/or rectified to ensure that the distribution of the skewed user group falls within the range of the distribution of the other user groups. In this way, the present invention debiases the virtual reality platform.

In some embodiments, the system may be configured to initiate an equilibrium testing protocol on the virtual reality platform. In this regard, the system may be configured to simulate a user balance equilibrium test on the virtual reality platform, wherein simulating further comprises physically moving the computing device in one or more axial directions. In response, the system may be configured to electronically receive, from one or more sensors associated with the computing device, a response to each movement in the one or more axial directions, wherein the response comprises at least an alert notification. In some embodiments, the system may be configured to determine a magnitude of motion associated with movement of the computing device in each of the one or more axial directions. In response, the system may be configured to determine a predetermined threshold associated with the magnitude of motion, wherein any movement along the one or more axial directions with the magnitude of motion greater than the predetermined threshold is considered a triggering motion. In response, the system may be configured to determine whether the alert notifications received from the one or more sensors in response to the movement of the computing device in the one or more axial directions matches the triggering motion in each of the one or more axial directions. In response, the system may be configured to determine a fourth exposure score associated with virtual reality platform based on at least a number of alert notifications that matches the triggering motion in each of the one or more axial directions.

In some embodiments, the system may be configured to assign a weight to the first exposure score, the second exposure score, the third exposure score, and the fourth exposure score. In response, the system may be configured to determine an overall exposure score based on at least the first exposure score, the second exposure score, the third exposure score, and the fourth exposure score. In one aspect, the overall exposure score may be a weighted average of the first exposure score, the second exposure score, the third exposure score, and the fourth exposure score. In response to determining the overall exposure score, the system may be configured to transmit control signals configured to cause the computing device associated with the user to display the overall exposure score for the virtual reality platform.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for enhanced data security in a virtual reality environment, the system comprising:
at least one non-transitory storage device storing a virtual reality platform; and
at least one processing device coupled to the at least one non-transitory storage device, wherein the at least one processing device is configured to:
initiate the virtual reality platform for display on a computing device associated with a user;
initiate an enhanced data security engine on the virtual reality platform, wherein initiating further comprises:
initiating an adversarial testing protocol on the virtual reality platform;
transmitting, via the adversarial testing protocol, one or more adversarial inputs to one or more trained machine learning models associated with the virtual reality platform;
electronically receiving, from the one or more trained machine learning models, one or more predicted class labels for the one or more adversarial inputs;
compare the one or more predicted class labels with one or more observed class labels associated with the one or more adversarial inputs;
determine an error rate of the one or more trained machine learning models based on at least comparing the one or more predicted class labels with the one or more observed class labels;
determine a first exposure score for the virtual reality platform based on at least the error rate of the one or more trained machine learning models;
transmit control signals configured to cause the computing device associated with the user to display the first exposure score for the virtual reality platform.

2. The system of claim 1, wherein the at least one processing device is further configured to:
determine, using the one or more trained machine learning models, that at least one of the one or more adversarial inputs matches one or more existing artifacts in the virtual reality platform based on at least the one or more predicted class labels;
introduce, using a noise generator, a noise value on the at least one of the one or more adversarial inputs that matches the one or more existing artifacts;
generate a noisy version of the at least one of the one or more adversarial inputs based on at least introducing a noise value to the at least one of the one or more adversarial inputs that matches the one or more existing artifacts; and
transmit control signals configured to cause the computing device associated with the user to display the noisy version of the at least one of the one or more adversarial inputs on the virtual reality platform.

3. The system of claim 1, wherein the at least one processing device is further configured to:
initiate the enhanced data security engine on the virtual reality platform, wherein initiating further comprises:
initiating an authentication testing protocol on the virtual reality platform;
transmitting a combination of authorized access requests and unauthorized access requests to access one or more features of the virtual reality platform;
electronically receiving, from the virtual reality platform, a response to the combination of authorized access requests and unauthorized access requests; and
determining a second exposure score for the virtual reality platform based on at least the response to the combination of authorized access requests and unauthorized access requests.

4. The system of claim 3, wherein the at least one processing device is further configured to transmit the combination of authorized access requests and unauthorized access requests, wherein the authorized access requests comprises requests with an authentication level that meets an authorization level required to access at least a portion of the one or more features of the virtual reality platform.

5. The system of claim 4, wherein the at least one processing device is further configured to: transmit the combination of authorized access requests and unauthorized access requests, wherein the unauthorized access requests comprises requests with an authentication level that does not meet the authorization level required to access at least the portion of the one or more features of the virtual reality platform.

6. The system of claim 5, wherein the at least one processing device is further configured to:
electronically receive information associated with the virtual reality platform, wherein the information comprises at least information associated with a content presented on the virtual reality platform, authentication requirements associated with the virtual reality platform, and adversarial management protocols associated with the virtual reality platform;
initiate a distribution detection protocol on the information associated with the virtual reality platform;
determine, using the distribution detection protocol, a distribution of one or more user groups likely to use the virtual reality platform based on at least the information associated with the virtual reality platform;
determine a skewness factor associated with the distribution of the one or more user groups likely to use the virtual reality platform; and
determine a third exposure score based on at least the skewness factor associated with the distribution of the one or more user groups likely to use the virtual reality platform.

7. The system of claim 6, wherein the at least one processing device is further configured to:
initiate an equilibrium testing protocol on the virtual reality platform, wherein initiating further comprises:
simulating a user balance equilibrium test on the virtual reality platform, wherein simulating further comprises physically moving the computing device in one or more axial directions; and
electronically receiving, from one or more sensors associated with the computing device, a response to each movement in the one or more axial directions, wherein the response comprises at least an alert notification.

8. The system of claim 7, wherein the at least one processing device is further configured to:
determine a magnitude of motion associated with movement of the computing device in each of the one or more axial directions;
determine a predetermined threshold associated with the magnitude of motion, wherein any movement along the one or more axial directions with the magnitude of motion greater than the predetermined threshold is considered a triggering motion;
determine whether the alert notifications received from the one or more sensors in response to the movement of the computing device in the one or more axial directions matches the triggering motion in each of the one or more axial directions; and
determine a fourth exposure score associated with virtual reality platform based on at least a number of alert notifications that matches the triggering motion in each of the one or more axial directions.

9. The system of claim 8, wherein the at least one processing device is further configured to:
assign a weight to the first exposure score, the second exposure score, the third exposure score, and the fourth exposure score;
determine an overall exposure score based on at least the first exposure score, the second exposure score, the third exposure score, and the fourth exposure score, wherein the overall exposure score is a weighted average of the first exposure score, the second exposure score, the third exposure score, and the fourth exposure score; and
transmit control signals configured to cause the computing device associated with the user to display the overall exposure score for the virtual reality platform.

10. A computer program product for enhanced data security in a virtual reality environment, the computer program product comprising a non-transitory computer-readable medium storing a virtual reality platform and comprising code causing a first apparatus to:
initiate the virtual reality platform for display on a computing device associated with a user;
initiate an enhanced data security engine on the virtual reality platform, wherein initiating further comprises:
initiating an adversarial testing protocol on the virtual reality platform;
transmitting, via the adversarial testing protocol, one or more adversarial inputs to one or more trained machine learning models associated with the virtual reality platform;
electronically receiving, from the one or more trained machine learning models, one or more predicted class labels for the one or more adversarial inputs;
compare the one or more predicted class labels with one or more observed class labels associated with the one or more adversarial inputs; and
determine an error rate of the one or more trained machine learning models based on at least comparing the one or more predicted class labels with the one or more observed class labels;
determine a first exposure score for the virtual reality platform based on at least the error rate of the one or more trained machine learning models; and
transmit control signals configured to cause the computing device associated with the user to display the first exposure score for the virtual reality platform.

11. The computer program product of claim 10, wherein the first apparatus is further configured to:
determine, using the one or more trained machine learning models, that at least one of the one or more adversarial inputs matches one or more existing artifacts in the virtual reality platform based on at least the one or more predicted class labels;
introduce, using a noise generator, a noise value on the at least one of the one or more adversarial inputs that matches the one or more existing artifacts;
generate a noisy version of the at least one of the one or more adversarial inputs based on at least introducing a noise value to the at least one of the one or more adversarial inputs that matches the one or more existing artifacts; and
transmit control signals configured to cause the computing device associated with the user to display the noisy version of the at least one of the one or more adversarial inputs on the virtual reality platform.

12. The computer program product of claim 10, wherein the first apparatus is further configured to:
initiate the enhanced data security engine on the virtual reality platform, wherein initiating further comprises:
initiating an authentication testing protocol on the virtual reality platform;
transmitting a combination of authorized access requests and unauthorized access requests to access one or more features of the virtual reality platform;
electronically receiving, from the virtual reality platform, a response to the combination of authorized access requests and unauthorized access requests; and
determining a second exposure score for the virtual reality platform based on at least the response to the combination of authorized access requests and unauthorized access requests.

13. The computer program product of claim 12, wherein the first apparatus is further configured to transmit the combination of authorized access requests and unauthorized access requests, wherein the authorized access requests comprises requests with an authentication level that meets an authorization level required to access at least a portion of the one or more features of the virtual reality platform.

14. The computer program product of claim 13, wherein the first apparatus is further configured to:
transmit the combination of authorized access requests and unauthorized access requests,
wherein the unauthorized access requests comprises requests with an authentication level that does not meet the authorization level required to access at least the portion of the one or more features of the virtual reality platform.

15. The computer program product of claim 14, wherein the first apparatus is further configured to:
electronically receive information associated with the virtual reality platform, wherein the information comprises at least information associated with a content presented on the virtual reality platform, authentication requirements associated with the virtual reality platform, and adversarial management protocols associated with the virtual reality platform;
initiate a distribution detection protocol on the information associated with the virtual reality platform;
determine, using the distribution detection protocol, a distribution of one or more user groups likely to use the virtual reality platform based on at least the information associated with the virtual reality platform;
determine a skewness factor associated with the distribution of the one or more user groups likely to use the virtual reality platform; and
determine a third exposure score based on at least the skewness factor associated with the distribution of the one or more user groups likely to use the virtual reality platform.

16. The computer program product of claim 15, wherein the first apparatus is further configured to:
initiate an equilibrium testing protocol on the virtual reality platform, wherein initiating further comprises:
simulating a user balance equilibrium test on the virtual reality platform, wherein simulating further comprises physically moving the computing device in one or more axial directions; and
electronically receiving, from one or more sensors associated with the computing device, a response to each movement in the one or more axial directions, wherein the response comprises at least an alert notification.

17. The computer program product of claim 16, wherein the first apparatus is further configured to:
determine a magnitude of motion associated with movement of the computing device in each of the one or more axial directions;
determine a predetermined threshold associated with the magnitude of motion, wherein any movement along the one or more axial directions with the magnitude of motion greater than the predetermined threshold is considered a triggering motion;
determine whether the alert notifications received from the one or more sensors in response to the movement of the computing device in the one or more axial directions matches the triggering motion in each of the one or more axial directions; and
determine a fourth exposure score associated with virtual reality platform based on at least a number of alert notifications that matches the triggering motion in each of the one or more axial directions.

18. The computer program product of claim 17, wherein the first apparatus is further configured to:
assign a weight to the first exposure score, the second exposure score, the third exposure score, and the fourth exposure score;
determine an overall exposure score based on at least the first exposure score, the second exposure score, the third exposure score, and the fourth exposure score, wherein the overall exposure score is a weighted average of the first exposure score, the second exposure score, the third exposure score, and the fourth exposure score; and
transmit control signals configured to cause the computing device associated with the user to display the overall exposure score for the virtual reality platform.

19. A method for enhanced data security in a virtual reality environment, the method comprising:
initiating a virtual reality platform for display on a computing device associated with a user;
initiating an enhanced data security engine on the virtual reality platform, wherein initiating further comprises:
initiating an adversarial testing protocol on the virtual reality platform;
transmitting, via the adversarial testing protocol, one or more adversarial inputs to one or more trained machine learning models associated with the virtual reality platform;
electronically receiving, from the one or more trained machine learning models, one or more predicted class labels for the one or more adversarial inputs;
compare the one or more predicted class labels with one or more observed class labels associated with the one or more adversarial inputs; and
determine an error rate of the one or more trained machine learning models based on at least comparing the one or more predicted class labels with the one or more observed class labels;
determining a first exposure score for the virtual reality platform based on at least the error rate of the one or more trained machine learning models; and
transmitting control signals configured to cause the computing device associated with the user to display the first exposure score for the virtual reality platform.

20. The method of claim 19, wherein the method further comprises:
determining, using the one or more trained machine learning models, that at least one of the one or more adversarial inputs matches one or more existing artifacts in the virtual reality platform based on at least the one or more predicted class labels;
introducing, using a noise generator, a noise value on the at least one of the one or more adversarial inputs that matches the one or more existing artifacts;
generating a noisy version of the at least one of the one or more adversarial inputs based on at least introducing a noise value to the at least one of the one or more adversarial inputs that matches the one or more existing artifacts; and
transmitting control signals configured to cause the computing device associated with the user to display the noisy version of the at least one of the one or more adversarial inputs on the virtual reality platform.
